(19) United States
(12) Patent Application Publication
(10) Pub. No.: US 2011/0141354 A1
(43) Pub. Date: Jun. 16, 2011

(54) DATA TRANSMITTING DEVICE, DATA RECEIVING DEVICE AND DATA TRANSMITTING AND RECEIVING SYSTEM

(75) Inventor: Shinetsu KATOU, Osaka (JP)

(73) Assignee: PANASONIC CORPORATION, Osaka (JP)

(21) Appl. No.: 12/949,554

(22) Filed: Nov. 18, 2010

(30) Foreign Application Priority Data
Nov. 19, 2009 (JP) 2009-263716

(51) Int. Cl. H04N 5/04

(52) U.S. Cl. 348/500; 348/E05.009

(57) ABSTRACT

A data transmitting device includes: clock frequency dividing unit, counting unit to perform counting, based on a base clock, of each cycle of a clock whose frequency has been divided by the clock frequency dividing unit; noise shaping unit to perform noise shaping to reduce the number of bits of an average count value in a plurality of cycles of the frequency-divided clock or a count value in a plurality of cycles of the frequency-divided clock; and transmitting unit to transmit the count value whose number of bits has been reduced by the noise shaping unit, the base clock, and a frequency division ratio used by the clock frequency dividing unit.

### CROSS-REFERENCE TO RELATED APPLICATION

This application is based upon and claims the benefit of priority of the prior Japanese Patent Application No. 2009-263716, filed on Nov. 19, 2009, the entire contents of which are incorporated herein by reference.

### FIELD

The present invention relates to an improvement of sound quality through an improvement of high definition multimedia interface (HDMI), which is known as one of the data interface standards for transmitting digital video and audio signals (digital contents).

### BACKGROUND

Recently, HDMI is becoming widely used. The reason for this is that all of the video, audio, and additional data can be transmitted with a single unit. HDMI has made the connection of digital equipment more convenient, enabling such equipment to be connected easily. However, essentially, HDMI is not an audio unit, and, thus, for example, some audio enthusiasts who eagerly desire high sound quality occasionally complain that the sound quality is not good. Actually, there are many cases in which countermeasures for mount noise that is a problem inherent in equipment are insufficient, but it seems that there is plenty of room for improvement in terms of seeking an ultimate system.

Inside ordinal audio-visual equipment, a clock for audio and a clock for video in many cases are generated independently of each other because they have different frequencies. HDMI transmits only a pixel clock for video instead of transmitting both of these two clocks, and, as for a clock for audio, employs a transmitting system called audio clock regeneration (ACR) in which the audio clock is regenerated based on the pixel clock. In this case, audio is reproduced by D/A converting audio data based on this regenerated clock.

FIG. 7 shows a block diagram of a conventional HDMI audio clock transmitting system. In FIG. 7, the audio clock transmitting system is configured from an HDMI transmitter 61 and an HDMI receiver 72. The HDMI transmitter 61 and the HDMI receiver 72 are connected to each other via an HDMI cable.

The HDMI transmitter 61 is configured of an N frequency divider 63, a cycle time counter 62, and an N value setting circuit 64. The N frequency divider 63 divides the frequency of an audio clock (128×fs) by a set N value. The cycle time counter 62 performs counting, based on the pixel clock, of a cycle of the audio clock whose frequency has been divided by 1, and outputs the obtained value as a CTS value (cycle time stamp value) to the receiver 72. The N value setting circuit 64 holds the set N value, and outputs this value to the frequency divider 61 and the receiver 72.

The HDMI receiver 72 is configured of a CTS frequency divider 74 and a frequency multiplier 75. The CTS frequency divider 74 divides the frequency of the pixel clock by the CTS value transmitted in packets. The frequency multiplier 75 multiplies the output of the CTS frequency divider 74 by N.

Next, an operation of the thus configured conventional HDMI audio clock transmitting system will be described. First, it is assumed that, when a sampling frequency fs is taken as 48 kHz, 6.144 MHz, which is 128 times the sampling frequency fs, is used as the audio clock. Furthermore, it is assumed that 148.5 MHz is used as the pixel clock for video in the case of high-definition television 1080 p. It is determined that a value around 128×fs/1000 Hz is used as the N value at that time, and a value of 6144 is defined to be used as a standard value in the HDMI standard.

When the above-described value is set, the output of the N frequency divider 63, that is, the input to the cycle time counter 62 is 1000 Hz, and, thus, the CTS value is 148500, which is obtained by dividing 148.5 MHz by 1 kHz. This CTS value is transmitted as packet data to the HDMI receiver 72. In the HDMI receiver 72, based on the N value and the CTS value transmitted in packets in a similar manner and the separately transmitted pixel clock, the frequency of the pixel clock is divided by the CTS frequency divider 74 by 148500 to obtain 1 kHz, and this signal is multiplied by the N frequency multiplier 75 by 6144, and, thus, the audio clock can be regenerated at 6.144 MHz.

However, for example, when there is an error between the audio clock and the pixel clock or when the operation timing of the cycle time counter 2 slightly shifts, fluctuation in the CTS value occurs. The fluctuation in the CTS value causes fluctuation in the audio clock in the output of the HDMI receiver 7, which causes distortion in reproduced audio signals.

### SUMMARY

The present application discloses a data transmitting device that transmits data and a base clock, including: clock frequency dividing unit to divide a frequency of a sample clock of the data by a given frequency division ratio, thereby generating a clock; counting unit to perform counting, based on the base clock, of each cycle of the clock whose frequency has been divided by the clock frequency dividing unit; noise shaping unit to perform noise shaping to reduce the number of bits of an average count value of values in a plurality of cycles, the values each being obtained by the counting unit performing counting of one cycle of the frequency-divided clock based on the base clock, or a count value obtained by performing counting of a plurality of cycles of the frequency-divided clock based on the base clock; and transmitting unit to transmit the count value whose number of bits has been reduced by the noise shaping unit, the base clock, and the frequency division ratio used by the clock frequency dividing unit.

### BRIEF DESCRIPTION OF THE DRAWINGS

FIG. 1 is a functional block diagram showing an exemplary configuration of a data transmitting and receiving system according to Embodiment 1 of the present invention.

FIG. 2 is a graph showing an exemplary partial digital waveshape of audio data reproduced using the audio clock.

FIG. 3 is a block diagram of an HDMI transmitter according to Embodiment 2 of the present invention.

FIG. 4 is a block diagram of a primary noise shaping circuit.

FIG. 5 is a block diagram of an HDMI transmitter according to Embodiment 3 of the present invention.

FIG. 6 is a block diagram of an HDMI receiver according to Embodiment 4 of the present invention.

FIG. 7 is a block diagram of a conventional audio clock transmitting system.

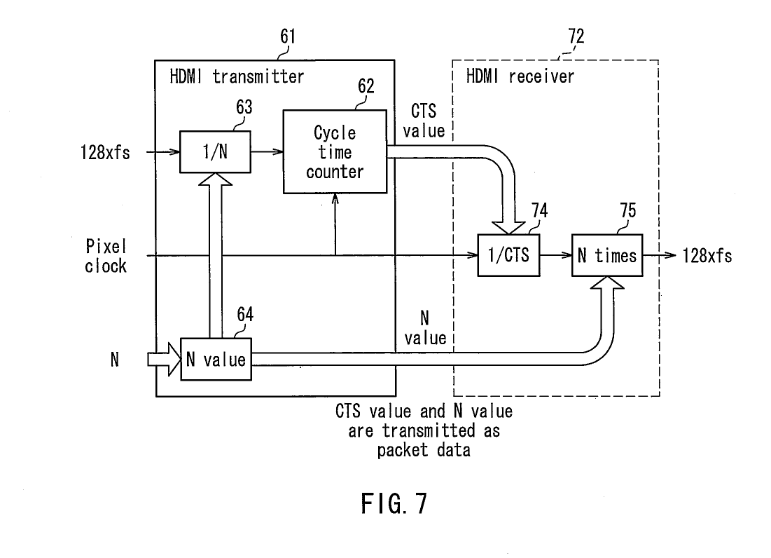

### EMBODIMENT

In order to calculate a CTS value that is to be transmitted, a data transmitting device of the present invention is provided with a cycle time counter, an averaging circuit that averages output values from the cycle time counter, and a noise shaping circuit that reduces the number of bits without decreasing the precision of the output of the averaging circuit, and transmits the output of the noise shaping circuit as the CTS value.

Next, a data transmitting device according to an embodiment of the present invention will be described with reference to the drawings.

### Embodiment 1

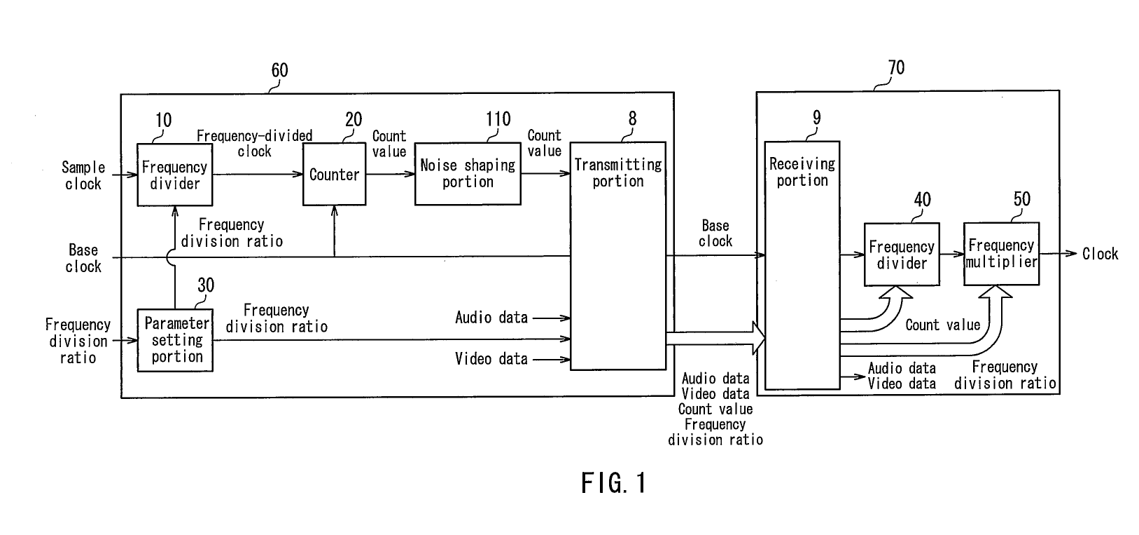

FIG. 1 is a functional block diagram showing an exemplary configuration of a data transmitting and receiving system including a data transmitting device according to Embodiment 1 of the present invention. The data receiving system shown in FIG. 1 includes a data transmitting device 60 that transmits data and a base clock, and a data receiving device 70 that receives the data and the base clock and regenerates a sample clock of the data. The data transmitting device 60 and the data receiving device 70 are connected to each other.

In the following embodiment, as an example, the case will be described in which data that is to be transmitted from the data transmitting device 60 to the data receiving device 70 includes audio data and video data, the base clock is a pixel clock of the video data, and the sample clock is an audio clock of the audio data. Here, the type of data and the combination of a base clock and a sample clock are not limited to these. For example, the following embodiment can be applied to a system that, when transmitting data that requires two types or more of clocks for reproduction and the like on the receiver side, transmits one clock and information indicating the relationship between this clock and the other clock, and regenerates the other clock using this one clock on the receiver side. The base clock and the sample clock also can be referred to as a first clock and a second clock.

The data transmitting device 60 is provided with a frequency divider 10, a counter 20, a noise shaping portion 110, a parameter setting portion 30, and a transmitting portion 8.

The frequency divider 10 is an example of a clock frequency dividing unit for dividing a frequency of the sample clock of the data by a given frequency division ratio, thereby generating a frequency-divided clock (intermediate clock). The frequency divider 10 outputs a clock having a frequency that is 1/N times (N is an integer) the frequency of the input clock. Here, it is assumed that the frequency division ratio is N. The frequency division ratio may be the value of N itself, or may be other values representing N. Typically, N is an integer, but does not necessarily have to be an integer.

The counter 20 is an example of a counting unit for performing counting, based on the base clock, of each cycle of the frequency-divided clock whose frequency has been divided by the frequency divider. The counter 20 can, for example, count the number of cycles of the base clock repeated in one cycle of the frequency-divided clock.

The noise shaping portion 110 generates a count value that is represented by a predetermined number of bits based on the output of the counter 20. The parameter setting portion 30 receives the input of the frequency division ratio, and notifies the frequency divider 10 and the transmitting portion 8 of the input frequency division ratio. The parameter setting portion 30 may notify the transmitting portion 8 of not only the frequency division ratio but also other necessary parameters. The count value and the frequency division ratio are an example of information indicating relationship between the base clock and the sample clock.

More specifically, the noise shaping portion 110 reduces the number of bits of an average count value of values in a plurality of cycles, the values each being obtained by performing counting of one cycle of the frequency-divided clock based on the base clock. At that time, the noise shaping portion 110 performs noise shaping to reduce the number of bits without decreasing the precision of the average count value to the extent possible.

Alternatively, the noise shaping portion 110 can reduce the number of bits of a count value obtained by performing counting of a plurality of cycles of the frequency-divided clock based on the base clock, and generate a count value of a predetermined number of bits. Also in this case, it is possible to suppress a decrease in the precision of the count value caused by reducing the number of bits through the noise shaping.

The noise shaping can include, for example, a process that suppresses a decrease in the precision of the data caused by quantization, by shifting quantization noise toward a frequency side on which the influence on the precision of the data is comparatively low, when quantizing and converting input signals into a data sequence of a predetermined number of bits.

In this embodiment, the noise shaping portion 110 calculates an average of count values in a plurality of cycles of the frequency-divided clock. For example, the average value can be calculated by adding count values in cycles of the frequency-divided clock for M cycles (M times), and dividing a value obtained by the addition by M. Furthermore, when addition of values for M times is started and the value obtained by the addition is stored in a buffer at every cycle of the frequency-divided clock, in each cycle, an average value in the previous M times at the time of this cycle can be output. It is possible to obtain a more accurate count value by averaging count values in this manner. Here, the average value does not necessarily have to be output at every cycle of the frequency-divided clock, and, for example, may be output at every one of a plurality of cycles. Furthermore, the average value does not necessarily have to be output at a timing according to the frequency-divided clock cycle.

As the bit reducing process, the following process may be employed. The noise shaping portion 110, for example, quantizes an average value calculated at a certain point in time into a value of a predetermined number of bits. Then, a difference between the value before the quantization and the value after the quantization is calculated, this difference is added to an average value calculated next, and the obtained value is quantized and output. This quantized value may be taken as the output value. Accordingly, a difference between the value before the quantization and the value after the quantization, that is, quantization noise can be shifted toward a high-frequency side. As a result, noise shaping that reduces the number of bits while suppressing a decrease in the precision of the average value can be performed.

In this case, the noise shaping portion 110 may be provided with, for example, an averaging circuit that averages count values obtained by the counter 20 performing counting in a manner as described above, and a noise shaping circuit that reduces the number of bits of the average count value obtained by the averaging circuit.

Alternatively, the noise shaping portion 110 can quantize a count value in each cycle of a clock obtained by further dividing the frequency of the frequency-divided clock, together with noise shaping in a similar manner. The count value in each cycle of the clock obtained by further dividing the frequency of the frequency-divided clock contains more precise information as in the case of the average value. When this count value is quantized into a value of a predetermined number of bits through noise shaping in a manner as described above, it is possible to reduce the number of bits of the count value while suppressing a decrease in the precision.

In this case, the noise shaping portion 110 may be provided with, for example, a second frequency divider that further divides, by a given frequency division ratio, the frequency of the frequency-divided clock whose frequency has been divided by the frequency divider 10, thereby generating a clock, and a noise shaping circuit that reduces the number of bits of a count value obtained by the counter 20 performing counting, based on the base clock, of each cycle of the clock generated by the second frequency divider.

The count value whose number of bits has been reduced by the noise shaping portion 110 is transmitted by the transmitting portion 8 to the receiving device 70 together with the base clock and the frequency division ratio used by the clock frequency dividing unit. Here, the audio data and the video data also are transmitted by the transmitting portion 8 to the receiving device 70. The data other than the base clock, that is, the count value, the frequency division ratio, the audio data, and the video data can be transmitted to the receiving device 70, for example, with time sharing using packet data.

The data receiving device 70 is provided with a receiving portion 9, a frequency divider 40, and a frequency multiplier 50. The receiving portion 9 (an example of receiving unit) receives the audio data, the video data, the base clock, the count value, and the frequency division ratio transmitted from the data transmitting device 60. The frequency divider 40 divides, by the count value, the frequency of the base clock received by the receiving portion 9, thereby generating a clock. The frequency multiplier 50 multiplies, by the frequency division ratio, the frequency of the clock generated by the frequency divider 40, thereby generating a clock. Accordingly, the sample clock is regenerated.

With the above-described configuration, the data transmitting device can transmit a count value of a predetermined number of bits in a plurality of cycles of the frequency-divided clock, while suppressing a decrease in the precision. Accordingly, a substantially precise sample clock can be transmitted.

For example, in the case where the sample clock is an audio clock of the audio data transmitted from the data transmitting device 60, the audio data received by the receiving device 70 is reproduced using the audio clock regenerated based on the base clock, the frequency division ratio, and the count value. When there is an error between the audio clock and the pixel clock or when the operation timing of the counter 20 slightly shifts, fluctuation occurs in the count value. The fluctuation in the count value causes fluctuation in the audio clock in the output of the data receiving device 70, which causes distortion in reproduced audio signals.

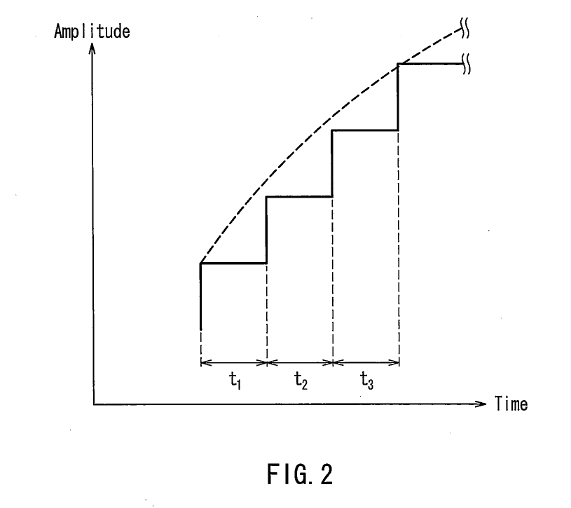

FIG. 2 is a graph showing an exemplary partial digital waveshape of audio data reproduced using the audio clock. In FIG. 2, a quantized digital waveshape is indicated by the solid line, and an audio signal waveshape before AD conversion is indicated by the dotted line. A width (t₁, t₂, and t₃) corresponding to a clock for one cycle of the digital waveshape shown in FIG. 2 fluctuates according to fluctuation in the count value. This causes fluctuation or jitter (inaccuracy) in the time axis for the digital waveshape. The fluctuation or jitter in the time axis causes distortion or noise in audio signals after DA conversion.

In this embodiment, as described above, a count value of a predetermined number of bits can be transmitted with a high precision. Thus, a substantially precise audio clock can be transmitted. As a result, distortion in reproduced audio signals is reduced, and sounds having a higher sound quality can be reproduced.

Here, in the above-described configuration, the transmitting portion 8 can transmit a count value in each cycle obtained by the counter 20 performing counting at least from when the counter 20 starts counting until when the counter 20 completes counting for the plurality of cycles. Accordingly, a delay in transmission of a count value by the noise shaping portion 110 can be avoided.

Furthermore, in the foregoing example, the noise shaping portion 110 is disposed in the data transmitting device 60, but the noise shaping portion 110 may be disposed in the data receiving device 70. In this case, the receiving portion 9 of the data receiving device 70 receives the base clock, the count value obtained by dividing the frequency of the sample clock of the data by a given frequency division ratio and performing counting of each cycle of the clock based on the base clock, and the frequency division ratio, all of which are transmitted by the data transmitting device 60. The noise shaping portion 110 of the data receiving device 70 performs noise shaping to reduce the number of bits of an average count value in a plurality of cycles of the frequency-divided clock or a count value in a plurality of cycles of the frequency-divided clock. The frequency divider 40 divides the frequency of the base clock by the count value whose number of bits has been reduced, thereby generating a clock. The frequency multiplier 50 multiplies the frequency of this clock by the frequency division ratio, and outputs the obtained value. Accordingly, the sample clock is regenerated.

### Embodiment 2

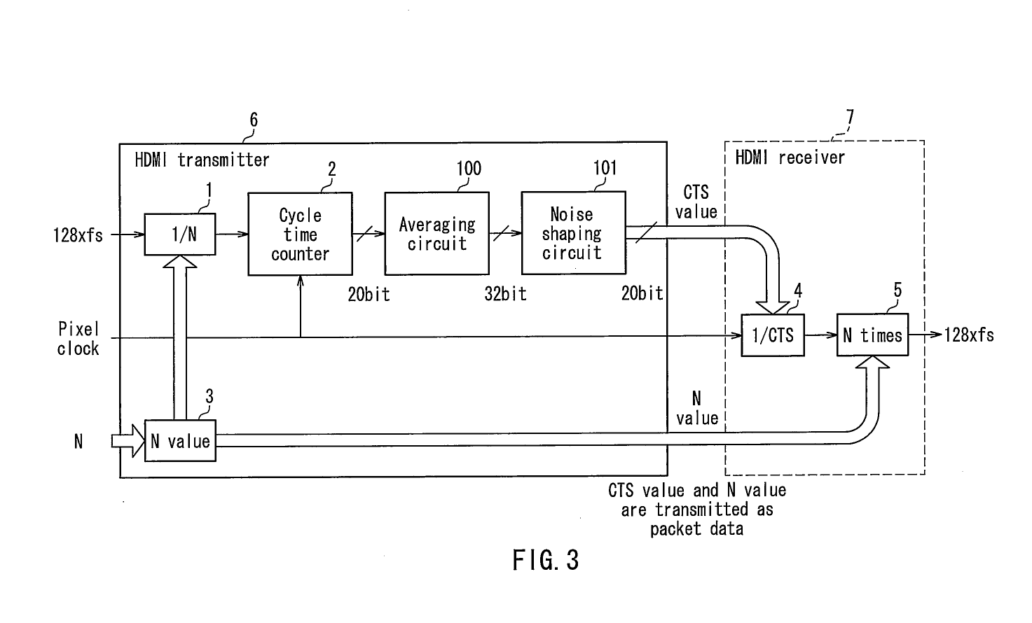

FIG. 3 shows a block diagram of an HDMI transmitter according to Embodiment 2 of the present invention. An HDMI transmitter 6 according to Embodiment 2 generates a CTS value through an expanded cycle time counter 2 of the conventional example. In FIG. 3, the HDMI transmitter 6 is configured from an N frequency divider 1 (indicated as “1/N” in FIG. 3), a cycle time counter 2, an N value setting circuit 3 (indicated as “N value” in FIG. 3), an averaging circuit 100, and a noise shaping circuit 101. The averaging circuit 100 averages output values from the cycle time counter 2. The noise shaping circuit 101 performs quantization noise shaping.

FIG. 3 shows an exemplary data transmitting and receiving system including the HDMI transmitter 6 as an example of a data transmitting device and an HDMI receiver 7 as an example of a data receiving device. Furthermore, the averaging circuit 100 and the noise shaping circuit 101 are a specific example of a noise shaping unit.

In the HDMI transmitter 6, the N frequency divider 1 is an example of a frequency dividing unit, and divides the frequency of an audio clock (128×fs) by an N value set by the N value setting circuit 3. The N value is an example of a value representing the frequency division ratio. In this example, N is a natural number, and the frequency division ratio 1/N indicates that the frequency is to be divided to obtain a 1/N frequency. The cycle time counter 2 is an example of a counting unit, and performs counting of a cycle of an audio clock (frequency-divided clock) whose frequency has been divided by the frequency divider 1, based on a pixel clock (an example of the base clock), and outputs the obtained value as a CTS value (cycle time stamp value) to the averaging circuit 100. The CTS value is an example of the count value.

The averaging circuit 100 is an example of averaging unit, and averages CTS values obtained by the cycle time counter 2 performing counting. For example, the averaging circuit 100 can add CTS values in cycles of the frequency-divided clock obtained by the cycle time counter 2 performing counting for a predetermined number of times M, divide a value obtained by the addition by the predetermined number of times M, and output the obtained value as an average value. More specifically, the averaging circuit 100 sequentially can receive CTS values in the cycles from the cycle time counter 2, add these values to a cumulative value of CTS values added by that time and stored in a buffer, divide, by M, the cumulative value in the buffer when the addition is performed M times, and output the obtained value as an average value of the CTS values. Furthermore, the averaging circuit 100 can calculate an average value in the previous M times at every cycle of the frequency-divided clock, for example, by using M pieces of buffer areas in which a value obtained by the addition is to be temporarily stored. Also in this case, the average value may be output at every one of a plurality of cycles of the frequency-divided clock, and the average value does not necessarily have to be output at a timing according to the frequency-divided clock. The thus calculated average value is a value having a higher accuracy and causing less fluctuation than an original count value. For example, it is possible to obtain a more accurate CTS value by setting M=1024 and calculating an average value of CTS values for 1024 times.

In order to obtain a more accurate average value, a larger number of times M for which CTS values are averaged is more preferable. However, if M is too large, the number of bits of the average value tends to exceed that of the CTS value as defined in the standard. In this case, the noise shaping circuit 101 reduces the number of bits of the average value of the CTS values obtained by the averaging circuit 100, and outputs the obtained value as a value of a predetermined number of bits. Here, a smaller amount of change in a CTS value enables the noise shaping circuit 101 to calculate an output value such that an error between a value after reduction of the number of bits and an original value, that is, noise is smaller.

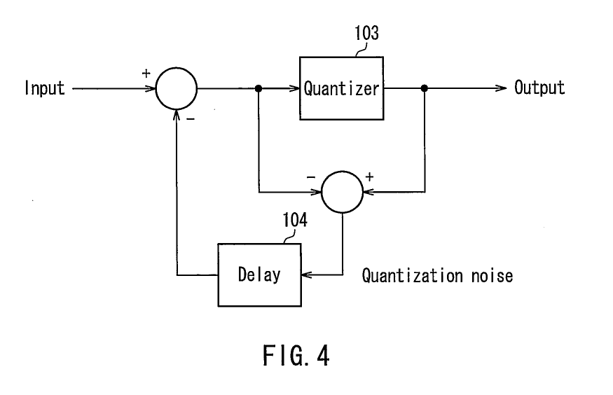

Hereinafter, an exemplary operation of the noise shaping circuit will be described. FIG. 4 shows an exemplary configuration of the simplest primary noise shaping circuit. The primary noise shaping circuit is provided with a quantizer 103 and a delay circuit 104. The quantizer 103 performs a process, for example, that rounds a 32-bit input signal down to a 20-bit signal, thereby reducing the number of bits of the output data. The noise shaping circuit shown in FIG. 4 further includes an adder that extracts a difference between the output and the input of the quantizer 103 and outputs the difference to the delay circuit 104, and an adder that adds a signal of the difference delayed by the delay circuit 104 and an input signal to the noise shaping circuit and outputs the obtained value to the quantizing circuit 103. Accordingly, the difference between the output and the input of the quantizer 103 is added to the next input signal (signal after one sampling time unit). In this configuration, it is possible to calculate an error caused by quantization by subtracting the input from the output of the quantizer 103. This error is referred to as quantization noise. When this quantization noise is indicated as VQ, and the delaying process is indicated as Z, Numerical Equation 1 is obtained from the drawing.

Output=Input+(1−Z)VQ Numerical Equation 1

Here, it is seen that “1−Z” indicates an operation that obtains a difference between data at the current time and data at the previous time, which is the same as the definition of differential. Accordingly, it is seen that, in the output of the circuit, a signal obtained by differentiating the quantization noise is added to the input signal. When this aspect is reconsidered with respect to quantization noise, it is not that quantization noise simply occurs but that noise whose shape has been changed as differential occurs. Thus, this circuit can be referred to as a noise shaping circuit because it is a circuit that changes the shape of noise. With the noise shaping process using the differential, low-frequency components of the noise decrease, and high-frequency components increase. That is to say, the smaller the amount of change between the previous data value and the current data value, the smaller the quantization noise added to the output. Reducing the size of the quantization noise is, as a result, the same as increasing the precision of output data. Since the current output of the sample time counter is typically a signal that substantially does not change, this noise reducing effect is significant. Here, it is possible further to reduce low-frequency noise by using a higher-order noise shaping circuit having steeper properties than those of the above-described primary noise shaping circuit.

Next, an operation of the HDMI transmitter 6 and the HDMI receiver 7 according to Embodiment 2 will be described.

A 20-bit CTS value is output from the noise shaping circuit 101. Here, 20 bit or more of information can be embedded therein, and, thus, input data having a corresponding precision is prepared. It is possible to calculate a value from which a more accurate CTS value is obtained, by averaging the output of the cycle time counter 21, for example, 1024 times using the averaging circuit 100. The averaging circuit 100 sends the thus obtained precise 32-bit data to the noise shaping circuit 101, and the noise shaping circuit 101 processes this data into a 20-bit signal and outputs the signal to the HDMI receiver 7.

The N value set by N value setting circuit 3 also is output to the HDMI receiver 7. Here, the N value and the CTS value transmitted using the HDMI system can be transmitted, for example, as packet data from the HDMI transmitter 6 to the HDMI receiver 7. These N value and CTS value are transmitted, for example, using a data island period in an HSYNC period of a video signal transmitted from the HDMI transmitter 6 to the HDMI receiver 7.

The HDMI receiver 7 is provided with a CTS frequency divider 4 (indicated as “1/CTS” in FIG. 3) and a frequency multiplier 5 (indicated as “N times” in FIG. 3). The CTS frequency divider 4 divides the frequency of the pixel clock by the CTS value transmitted in packets. For example, the CTS frequency divider 4 can output a clock having a frequency obtained by dividing, by the CTS value, the frequency of the pixel clock received from the HDMI transmitter 6, as a frequency-divided clock (intermediate clock).

The frequency multiplier 5 multiplies the output of the CTS frequency divider 4 by N times. The frequency multiplier 5 can be configured from a phase locked loop (PLL) circuit. More specifically, the PLL circuit used in the frequency multiplier 5 may be provided with a phase detector, a low-pass filter (LPF), a voltage control oscillator (VCO), and a 1/N frequency divider that divides the frequency of a signal output by the VCO to obtain a 1/N frequency and inputs the obtained signal to the phase detector, these constituent elements being connected in series. The phase detector outputs a control signal based on a phase difference between the output signal of the CTS frequency divider 4 and the output signal of the 1/N frequency divider, and the VCO outputs a clock having a frequency that is N times that of the frequency-divided clock based on the control signal sent via the LPF. With such a PLL circuit, the frequency of the frequency-divided clock output from the CTS frequency divider 4 is multiplied by N times.

The HDMI receiver 7 receives a CTS value that seemingly changes at a high speed, but, actually, the quantization noise simply is subjected to shaping so as to be shifted toward a high-frequency side. By configuring the PLL circuit used in the N frequency multiplier 5 so as to have an LPF characteristic that follows slow fluctuation in the frequency of an input signal and does not respond to fast fluctuation, it is possible to perform control such that slow fluctuation in the CTS value affects an audio clock that is to be output, but fast fluctuation caused by noise shaping or the like is not considered. Accordingly, an audio clock is regenerated with a precise CTS value that has been left after removal of high-frequency components in the PLL circuit of the N frequency multiplier 5, and audio having a high sound quality is reproduced.

Furthermore, from the viewpoint of the response time, it is possible to start transmission at high speed, by outputting only the first CTS value so as not to pass through the averaging circuit 100 and first causing the receiver side to start clock generation, and then transmitting precise data from the next CTS value.

For example, from when the cycle time counter 2 starts counting until when the cycle time counter 2 completes counting for M cycles, the HDMI transmitter 6 may transmit the CTS value output by the cycle time counter 2 directly to the HDMI receiver 7 so as not to pass through the averaging circuit 100 and the noise shaping circuit 101. More specifically, a switch circuit can be provided that switches, according to the counting state of the cycle time counter 2, between directly outputting the output of the cycle time counter 2, and outputting the output via the averaging circuit 100 and the noise shaping circuit 101.

In this embodiment described above, it is possible to generate a clock having a high sound quality from the output of the HDMI receiver 7 while reducing the influence of fluctuation in the CTS value to the extent possible.

### Embodiment 3

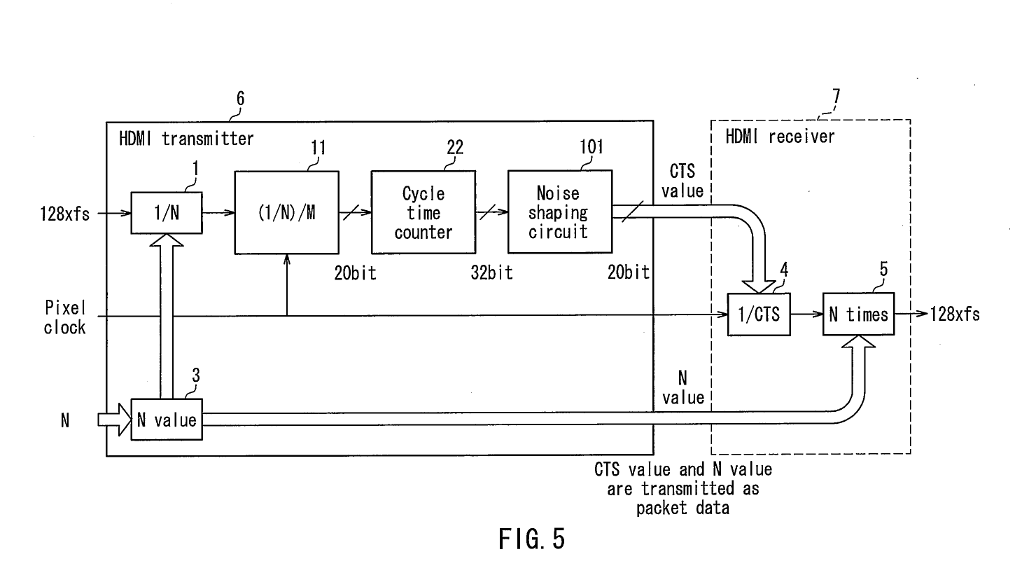

FIG. 5 shows a block diagram of an HDMI transmitter according to Embodiment 3 of the present invention. The HDMI receiver 6 according to Embodiment 3 generates a CTS value through an expanded cycle time counter 2 of the conventional example. In FIG. 5, the HDMI transmitter 6 is provided with the N frequency divider 1 (indicated as “1/N” in FIG. 5), an NM frequency divider 11 (indicated as “(1/N)/M” in FIG. 5), a cycle time counter 22, and the noise shaping circuit 101.

The NM frequency divider 11 is a frequency divider employing a frequency division ratio larger than that of the N frequency divider 1. The cycle time counter 22 can perform counting in a longer time than the cycle time counter 2 of Embodiment 2. The NM frequency divider 11 further divides, by a given frequency division ratio (1/M in this example), the frequency of the clock whose frequency has been divided by the N frequency divider 1, thereby generating a clock. The cycle time counter 22 performs counting, based on the pixel clock, of each cycle of the clock generated by the NM frequency divider 11. That is to say, the cycle time counter 22 performs counting, based on the pixel clock, of one cycle of the clock obtained by dividing the frequency of an audio clock (128×fs) by the frequency division ratio (1/N)/M. The count value is input to the noise shaping circuit 101. This count value is the same as a value obtained by adding, M times, a count value in one cycle of the clock obtained by dividing the frequency of the audio clock by the frequency division ratio (1/N).

As in Embodiment 2, a 20-bit CTS value is output from the noise shaping circuit 101. Here, 20 bit or more of information can be embedded therein, and, thus, input data having a corresponding precision is prepared. Setting is made such that the frequency division ratio of the MN frequency divider 11 is M=1024, and the frequency is divided another 1024 times, and the cycle time counter 22 performs counting for a long period of time. Accordingly, it is possible to calculate a value from which a more accurate CTS value is obtained. The thus obtained precise 32-bit data is sent to the noise shaping circuit 101. The noise shaping circuit 101 processes this data into a 20-bit signal and outputs the signal to the HDMI receiver 7. The following operation is similar to that in Embodiment 2. Furthermore, according to the configuration of the HDMI transmitter 6 shown in FIG. 5, it is possible to obtain a count value that is as accurate as the average value of Embodiment 2 without performing the adding process as in Embodiment 2. In this manner, according to this embodiment, it is possible to obtain a precise CTS value with a simple process.

Furthermore, from the viewpoint of the response time, it is possible to start transmission at high speed, by generating and outputting only the first CTS value without increasing the frequency division ratio of the MN frequency divider 11 and first causing the receiver side to start clock generation, and then transmitting precise data from the next CTS value.

Here, the ranges of high-frequency and low-frequency will be described. The output timing of the cycle time counter 2 of the conventional example is determined by setting of the N value, and is set to approximately 1 kHz. This frequency corresponds to the phase detection frequency of the PLL of the N frequency multiplier circuit 5, and, thus, the response frequency of the PLL is set to approximately 100 Hz or less at the highest. Accordingly, it can be considered that the high frequency refers to a frequency of 100 Hz or more. Thus, the low frequency naturally will refer to a frequency of less than 100 Hz, but, when “low frequency” is specifically indicated, it is assumed that this term refers to a frequency lower than the above-described range. The concept of the high frequency and the low frequency can be applied also to Embodiment 2 described above and Embodiment 4 described below.

Regarding the packet transmission frequency of the N value and the CTS value in HDMI transmission, as described by CQ Publishing Co., Ltd. in “Design Wave Magazine”, April 2008, pp. 73-81, these values are transmitted using a data island period in an HSYNC period of a video signal, and, thus, the N value and the CTS value can be updated at approximately 15 kHz at the maximum in the case of 480 p, which is sufficiently higher than the above-described frequency. Here, it should be noted that a time during which packets cannot be sent is present in a VSYNC period, but, during this time, the operation of noise shaping itself does not change even if the operation is delayed for the delay time in the noise shaping circuit, and the noise shaping effect during this time is merely lowered, which does not cause a significant problem.

A cycle at which the CTS packet specifically is changed can be set within the range that is allowed according to the conditions regarding packet transmission and the like as described above. If the update of the CTS packet is too late, that is, if the CTS value change cycle is too long, the effect is lost. Thus, the transmission frequency of the CTS packet is preferably higher than the standard. For example, a configuration may be employed in which an ordinary CTS value first is transmitted, the compatibility is checked, and a CTS value subjected to noise shaping is then transmitted. Here, it can be said that the delaying process value Z in Numerical Equation 1 above is a value indicating the update frequency of the CTS value. Thus, for example, it is possible to adjust the update frequency of the CTS value by setting the delay unit 104 of the noise shaping circuit shown in FIG. 4.

In the case where the operation can be confirmed, for example, because the devices are manufactured by the same manufacturer, setting not following the standard values as defined in the HDMI standard is possible in which transmission is performed while setting the N value to a smaller value and also setting the CTS value to a smaller value. When the CTS value is set to a smaller value, typically, relative errors in the CTS value increase, and the sound quality decreases. Thus, this CTS value can be subjected to noise shaping to increase the precision, and thus transmitted at a high frequency, using the techniques described in Embodiments 1 or 2 described above or Embodiment 4 described below. Accordingly, a significant sound quality improving effect can be exerted.

### Embodiment 4

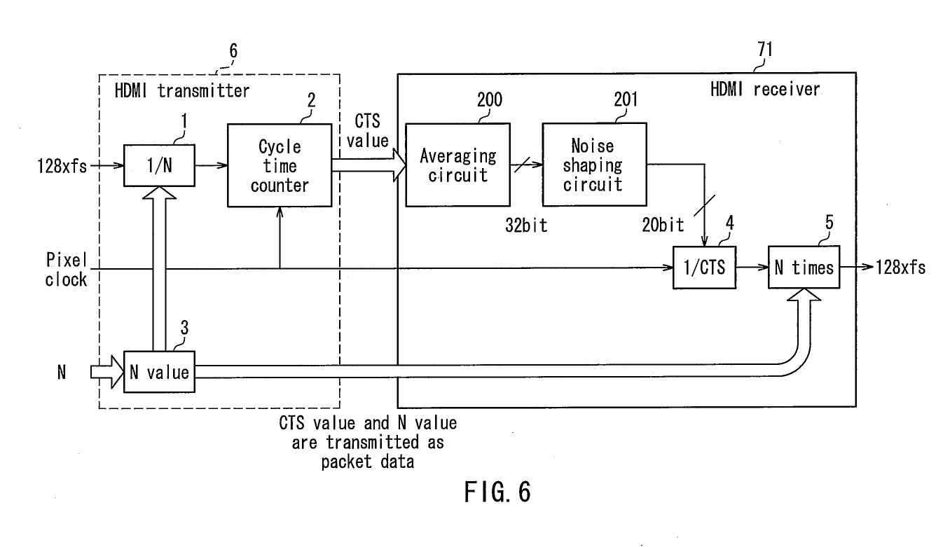

FIG. 6 shows a block diagram of an HDMI receiver according to Embodiment 4 of the present invention. In Embodiment 1, the averaging circuit and the noise shaping circuit are arranged on the HDMI transmitter side, but, in Embodiment 4, the constituent elements corresponding to these are arranged on the HDMI receiver side. An HDMI receiver 71 is provided with an averaging circuit 200, a noise shaping circuit 201, the CTS frequency divider 4, and the frequency multiplier 5.

The HDMI transmitter 6 transmits a CTS value obtained by obtained by performing counting, based on the pixel clock, of each cycle of an audio clock whose frequency has been divided to obtain a 1/N frequency, to the HDMI receiver 71. The averaging circuit 200 of the HDMI receiver 71 calculates an average value of the CTS values for M times. The average value is output to the noise shaping circuit 201, for example, in 32 bits. The noise shaping circuit 201 performs noise shaping to reduce the number of bits of the 32-bit average value into a 20-bit value, and outputs the obtained value to the CTS frequency divider 4. Such averaging and noise shaping of the CTS value can be performed as in Embodiment 2 or 3 described above. Furthermore, the CTS frequency divider 4 and the frequency multiplier 5 also can operate as in Embodiment 2 or 3 described above.

When the present invention is regarded as a total system, a higher versatility is obtained when the averaging and noise shaping functions are arranged on the HDMI transmitter side because the sound quality can be improved regardless of the type of an HDMI receiver. However, when these functions are arranged on both the HDMI transmitter side and the HDMI receiver side, the sound quality can be improved in two steps, and a higher effect can be exerted. Furthermore, when the averaging circuit and the noise shaping circuit are arranged in the HDMI receiver, the sound quality can be improved without changing the configuration of the HDMI transmitter.

Here, the example shown in FIG. 6 shows a configuration in which the reduction of the number of bits is performed together with averaging and noise shaping of the CTS value in the HDMI receiver. Meanwhile, for example, a configuration also may be employed in which the HDMI transmitter 6 generates a CTS value by dividing the frequency of an audio clock using the frequency divider 1 to obtain a 1/N frequency, further dividing the frequency of the thus obtained clock to obtain a 1/M frequency, and performing counting of the finally obtained clock based on the pixel clock, and the HDMI receiver 71 receives the CTS value of the clock whose frequency has been divided to obtain a (1/N) M frequency and performs noise shaping to reduce the number of bits. In this manner, the HDMI transmitter 6 may be provided with not only the N frequency divider 1 and the cycle time counter 2 but also an NM frequency divider, and the HDMI receiver 71 may be provided with the noise shaping circuit 201, the CTS frequency divider 4, and the frequency multiplier 5.

Here, in Embodiments 2 to 4 of the present invention, the number of bits 32 is used in the number of averaging processes, the counting time, and the like, but the number of bits may be numbers other than 32. Furthermore, the configuration of the noise shaping circuit is not limited to that in the example shown in FIG. 4. For example, a secondary or higher-order noise shaping circuit may also be used.

The functional blocks shown in Embodiments 1 to 4 described above may be configured from an electronic circuit including wires and elements of a printed-circuit board, or may be configured from IC chips integrated on a semiconductor substrate. For example, in the configuration shown in FIG. 1, the frequency divider 10, the counter 20, and the noise shaping portion 110 can be integrated on one semiconductor substrate.

When the data transmitting device, the data receiving device, and the data transmitting and receiving system of the present invention are used, for example, in an HDMI audio transmitting and receiving device, audio having a high quality can be reproduced.

What is claimed is:

1. A data transmitting device that transmits data and a base clock, comprising:
clock frequency dividing unit to divide a frequency of a sample clock of the data by a given frequency division ratio, thereby generate a clock;
counting unit to perform counting, based on the base clock, of each cycle of the clock whose frequency has been divided by the clock frequency dividing unit;
noise shaping unit to perform noise shaping to reduce the number of bits of an average count value of values in a plurality of cycles, the values each being obtained by the counting unit performing counting of one cycle of the frequency-divided clock based on the base clock, or a count value obtained by performing counting of a plurality of cycles of the frequency-divided clock based on the base clock; and
transmitting unit to transmit the count value whose number of bits has been reduced by the noise shaping unit, the base clock, and the frequency division ratio used by the clock frequency dividing unit.

2. The data transmitting device according to claim 1, further comprising averaging unit to average count values obtained by the count generating unit performing counting,
wherein the noise shaping unit reduces the number of bits of the average count value obtained by the averaging unit.

3. The data transmitting device according to claim 1, further comprising second clock frequency dividing unit to further divide, by a given frequency division ratio, a frequency of the clock whose frequency has been divided by the first clock frequency dividing unit, thereby generating a clock,
wherein the counting unit performs counting, based on the base clock, of each cycle of the clock generated by the second clock frequency dividing unit, and
the noise shaping unit reduces the number of bits of the count value obtained by the counting unit performing counting.

4. The data transmitting device according to claim 1, wherein the transmitting unit transmits a count value in each cycle obtained by the counting unit performing counting at least from when the counting unit starts counting until when the counting unit completes counting for the plurality of cycles.

5. A data receiving device that receives data and a base clock and regenerates a sample clock of the data, comprising:
receiving unit to receive the base clock, a count value obtained by performing counting of each cycle of a clock based on the base clock, the clock being obtained by dividing a frequency of the sample clock of the data by a given frequency division ratio, and the frequency division ratio, all of which are transmitted by a data transmitting device;
noise shaping unit to perform noise shaping to reduce the number of bits of an average count value of values in a plurality of cycles, the values each being obtained by the counting unit performing counting of one cycle of the frequency-divided clock based on the base clock, or a count value in a plurality of cycles of the frequency-divided clock;
clock frequency dividing unit to divide a frequency of the base clock received by the receiving unit, by the count value generated by the noise shaping unit, thereby generating a clock; and
clock frequency multiplying unit to multiply a frequency of the clock generated by the clock frequency dividing unit, by the frequency division ratio, thereby generating a clock.

6. The data receiving device according to claim 5, further comprising averaging unit to average count values received by the receiving unit,
wherein the noise shaping unit reduces the number of bits of the average count value obtained by the averaging unit.

7. The data receiving device according to claim 5,
wherein the receiving unit receives the base clock, a count value obtained by dividing a frequency of the sample clock of the data by a given frequency division ratio, further dividing a frequency of the obtained clock by a second frequency division ratio, and then performing counting of each cycle of the finally obtained clock based on the base clock, the frequency division ratio, and the second frequency division ratio, all of which are transmitted by the clock transmitting unit, and
the data receiving device further comprises noise shaping unit to reduce the number of bits of the count value received by the receiving unit.

8. A data transmitting and receiving system, comprising:
a data transmitting device that transmits data and a base clock; and
a data receiving device that is connected to the data transmitting device and that receives the data and the base clock and regenerates a sample clock of the data;
wherein the data transmitting device comprises:
first clock frequency dividing unit to divide a frequency of the sample clock of the data by a given frequency division ratio, thereby generating a clock;
counting unit to perform counting, based on the base clock, of each cycle of the clock generated by the first clock frequency dividing unit; and
transmitting unit to transmit the base clock, the count value, and the frequency division ratio,
the data receiving device comprises:
receiving unit to receive the base clock, the count value, and the frequency division ratio, all of which are transmitted by the clock transmitting unit
second clock frequency dividing unit to divide, by the count value, a frequency of the base clock received by the receiving unit, thereby generating a clock; and
clock frequency multiplying unit to multiply a frequency of the clock generated by the second clock frequency dividing unit, by the frequency division ratio received by the receiving unit, thereby generating a clock, and
either one of the data transmitting device and the receiving device comprises noise shaping unit to perform noise shaping to reduce the number of bits of an average count value of values in a plurality of cycles, the values each being obtained by the counting unit performing counting of one cycle of the frequency-divided clock based on the base clock, or a count value in a plurality of cycles of the frequency-divided clock.

9. The data transmitting and receiving system according to claim 8,
wherein the data transmitting device further comprises averaging unit to average count values obtained by the count generating unit performing counting, and
the noise shaping unit reduces the number of bits of the average count value obtained by the averaging unit.
